(19) United States
(12) Patent Application Publication
(10) Pub. No.: US 2016/0262416 A1
(43) Pub. Date: Sep. 15, 2016

(54) PROCESS FOR REMOVING CAFFEINE FROM GREEN COFFEE AND PLANT FOR IMPLEMENTING THE PROCESS

(71) Applicant: DEMUS S.p.A., Trieste (IT)

(72) Inventors: Yves Clyford DESOBGO NGUEPI, Trieste (IT); Massimiliano FABIAN, Trieste (IT); Ennio MARCHESAN, Trieste (IT); Stefano TRAUNINI, Trieste (IT)

(73) Assignee: DEMUS S.p.A., Trieste (IT)

(21) Appl. No.: 15/030,676

(22) PCT Filed: Oct. 21, 2013
(86) PCT No.: PCT/IT2013/000295

§ 371 Date: Apr. 20, 2016

(51) Int. Cl. A23F 5/20

(52) U.S. Cl. CPC A23F 5/208

(57) ABSTRACT

The phases included in the process of pre-drying in an extractor (1) the aromatic solution decaffeinated by the active carbons; concentrating the solution in a concentration apparatus (5) and transferring it again into the extractor (1) held in such a vacuum degree (11) that helps the reincorporation of aromatic substances in the pre-dried coffee; drying, cooling and discharge the decaffeinated coffee.

### FIELD OF THE INVENTION

The present invention relates to a process and a plant for removing caffeine from green coffee.

### STATE OF THE ART

As well known, the market offers both coffee containing its own natural percentage of caffeine and coffee referred to as “decaffeinated” obtained by removing caffeine from green coffee or raw coffee.

The good processes used for removing caffeine from green coffee are basically belonging to four different types and are numerous. The process object of the present patent application is a “water process”, in particular a process by water and active carbons, and the known processes of this type and closest to the one invented are implemented and probably patented by firms Swiss Water and Nestlé.

Consider that one of the drawbacks of the “water processes” is that of removing from coffee, in addition to caffeine, many water-soluble aromatic substances that would help to give the coffee, roasted and served in a cup, the well appreciated aroma.

In the process of Swiss Water, each batch of green coffee is treated in an aqueous solution, caffeine-free and rich in coffee aromatic substances.

The process of Nestlé provides for the passage of the aqueous solution through one or more extractors in series loaded with green coffee before the solution proceeds to one or more columns of active carbons in series without then making it to return into the extractors, by extractor being intended a container in which hot water removes caffeine from coffee beans

The main drawback in the Swiss Water process lies in the potential alteration of the aromatic profile of the product obtained when the coffee batches under process are of origins different from those used for preparing the aromatic solution used for decaffeination.

The main disadvantage of the Nestlé process is to extract most of the water-soluble substances together with caffeine. Indeed, in this process the amount of water-soluble aromatic substances extracted from the coffee is strong, and then the next phase of reincorporation of these substances into the coffee is of limited efficacy and long in terms of time.

Scopes of the Invention.

The main scopes of the invention are to obtain a product organoleptically superior to the standard ones obtained with the known water processes, in an economically sustainable way and with a high degree of decaffeination, not least that of obtaining a complete saturation of the active carbons with a consequent reduction of the cost for their regeneration.

### DISCLOSURE OF THE INVENTION

According to the invented process, a batch of green coffee is introduced into a container-extractor (hereinafter referred to as “extractor”) containing softened water maintained at a conventional work temperature and under constant mixing where the coffee beans are left in the hot water for the time period necessary for their swelling in order to allow the transfer into the hot water of part of the caffeine and aromatic water-soluble substances contained in the coffee, so forming what will be hereinafter referred to as “solution”, the process being characterized in that transfer of other caffeine quantity is achieved from the solution to the activated carbons and a phase follows that diffuses within the coffee beans, now decaffeinated, in the process, the aromatic substances previously transferred from the coffee to the hot water, a slight vacuum being created in the extractor that helps this phase that in the following will be simply called “reincorporation”.

So it is realized that, as a basic step in the process, after a certain time during which the hot water and the coffee have been in contact in the extractor, as necessary for the completion of the coffee swelling and before the reincorporation phase, the solution was made to pass through activated carbons in order to be decaffeinated and forwarded again in the extractor according to a known circuit movement called “Merry-Go-Round”.

It so happens then that the coffee releases caffeine into the hot water and the latter is forwarded to the containers of activated carbons that retain the caffeine. The invented process gets an equilibrium between residual caffeine in the coffee and residual caffeine in the aqueous solution so as to obtain a decaffeinated coffee having a final caffeine content of not more than 0.1%.

The solution, once depleted of caffeine, is transferred from the extractor in a concentration plant and put back again into the extractor held under a slight vacuum where the pre-dried coffee reincorporates the most of the water-soluble aromatic substances.

The process ends with a final drying and cooling of the coffee.

The weight ratio water/coffee is conventionally comprised, as mentioned in the patent NT—U.S. Pat. No. 4,508,743, between 3/1 and 15/1. The weight of activated carbons is generally 18-36% of that of the green coffee to be decaffeinated and, as suggested by the above patent, the working temperature of the aqueous solution is preferably comprised between 60° C. and 90° C.

The extractor is a container comprising softened water at ambient temperature or already brought to a desired temperature in an upstream heating means. The extractor also comprises in its lower part a porous septum suitable to prevent the exit of coffee beans and let the solution and the non water-soluble substances, like coffee films, to pass through. As to columns, before entering them, the solution is passed through a filter provided with meshes between 50 and 250 micrometers which retain the non soluble substances like the coffee chaff.

The process can be conducted in two different ways.

In a first way, the solution is passed through a container of activated carbons and put-back again in the extractor for a time sufficient to obtain the desired degree of decaffeination. This way is considered as a one-stage process.

In the one-stage process, on ending the predetermined time period for the recirculation through the container of active carbons already partially saturated, container hereinafter simply referred to as “first column”, the solution is transferred in one or more containers of fresh active carbons, hereinafter referred to simply as “second column/s”.

In a second way, the solution is still passed through the activated carbons, but in two subsequent stages; in a first stage, using active carbons already partially saturated with caffeine from a previous batch and, in a second stage, using fresh active carbons. This way is considered as a two-stage process.

The above mentioned two stages in the second way of proceeding are described here below, with the premise that the flow of the solution in the active carbons containers can be arranged both “upwards” and “downwards”, i.e., the solution can be fed both from the bottom upwards and from the top to bottom of the carbons bed through distributors with filtering effect. In the case in which it is used a flow “downwards”, the minimum level of the aromatic solution is ensured by an outlet pipe U inverted. The solution recirculation flow is measured and adjusted so as to get an adequate recirculation.

The operation is interrupted for changing the filter once the pressure drop in the system becomes excessive or, without interrupting the operation, the clogged filter is isolated and a fresh alternative filter is activated, mounted in parallel with the other.

In the two-stage process, the removal of caffeine entails that the solution coming from the first column, where carbons are already saturated to their maximum, is passed through the second columns and recirculated back into the extractor. This procedure will be hereafter referred to as “recirculation”. Once the predetermined recirculation time period is finished, the solution is diverted to a concentration apparatus in order to start the concentration step, the recirculation time through the second columns being in general higher than that chosen for the recirculation in the first column.

The passage of the solution through the columns is done in series if the control on line of the caffeine contents shows a value higher than expected, this passage being optionally feasible in parallel in the said conditions.

After completely removing the solution from the extractor, the coffee pre-drying phase can start until a humidity between 10% and 45% is reached.

In summary, the process comprises the phases claimed in the claims.

### The Advantages of the Process

The invented process provides many benefits. The reincorporation of aromatic substances in the coffee is optimized thanks to the slight vacuum generated into the extractor, preferably by means of a peristaltic pump. Furthermore, the fact the stirrer blades, which give the mass aromatic solution and coffee a continuous motion upwards and downwards within the extractor, causes that the circuit movement of the solution between the activated carbons and the extractor, circuit movement already mentioned and called “Merry-Go-Round”, increases the speed in removing caffeine from coffee and eliminates the risk of formation of preferential passages through the coffee bed in the extractor. So, not only a homogeneously decaffeinated coffee but also and especially a particularly clean coffee is produced thanks to the mechanical action exerted by the stirrer blades into the extractor. These effects are of fundamental importance in the delicate phase of reincorporation of the aromas previously extracted from the coffee. In fact, if there was the presence of films or of not water soluble substances during reincorporation, “slime” would form that would prevent the homogeneous reincorporation of the coffee aromas and produce a little aromatic decaffeinated coffee and the presence of many solids on the outer surface of the beans. Moreover, the condensed water during the concentration phase is recovered and reused as coffee swelling water in the batch of coffee to be subsequently treated. Finally, in the case of the process described later in Example 2, a significant lower consumption of active carbons is achieved because their absorption capacity is fully utilized with consequent reduction of the costs of the next phase for regenerating the exhaust carbons.

### EXAMPLES OF EMBODIMENTS

The invented process will now be illustrated in detail by examples of the two different types of process as described above.

### Example 1

Two-stage process—In an extractor of 50 L capacity, equipped with heating coils and a stirrer, 10 kg of green coffee are loaded along with 30 kg of softened water heated up to a temperature of 85° C. After one hour, the solution prepared therein is passed at a rate of 60 L/hour through a column loaded with 3.65 kg of fresh activated carbons of GAC type (granular activated carbon). At the end of each predetermined recirculation time period, the coffee is pre-dried and the solution is concentrated and reforwarded to the extractor to be reincorporated into the coffee. In the attached Table 1 the values are reported of residual caffeine in the coffee reincorporated until a residual value of 0.04% is reached.

### Example 2

One stage process—The procedure described in Example 1 is repeated, with some changes. Indeed, in this case the solution is first passed for 2 hours through a first column loaded with 1.6 kg of activated carbons pre-saturated in a previous batch of coffee where the recirculation time period was 4 hours. At the end of the first recirculation, the solution is forwarded to a second column loaded with 1.6 kg of fresh active carbons. The recirculation time period through the second column is 4 hours. The recirculation flow is 60 L/hour. In the attached Table 2 the values are reported of residual caffeine in the coffee reincorporated until a residual value of 0.04% is reached.

The processes described in the previous examples were compared with a conventional process where the coffee is not subject to the mechanical action of the stirrer, but remains stationary so forming a bed of coffee beans. It was found that the advantage in term of remotion of non-soluble substances, such as the chaff present during the stage of reincorporation carried out in a drum provided with a stirrer, is all in favour of a plant where the extractor is provided with stirrers which lead to a lower quantity of non-soluble substances in the solution. The quantity of eliminated non-soluble substances ranges from 0.5% and 1.2% of the weight of the coffee. The absence of a stirrer causes a low aromatic profile in the stage of tasting a batch of decaffeinated coffee.

Reincorporation of Water-Soluble Substances

In this phase of reincorporation, the pre-dried coffee is put in contact with the aromatic solution previously concentrated. A recirculation pump is used for moving aromas to be reincorporated, preferably a peristaltic pump, extracting the solution of aromas from the bottom of the extractor, passing through a filter and the pump and putting it in head of the extractor (see attached diagram in the path 1-9-11-1). This pump generates a slight vacuum into the extractor, between 0.65 and 0.99 bar, which helps to maximize the reincorporation of aromatic substances in the coffee.

The complete reincorporation is obtained in two stages:

The first phase, which corresponds to the absorption of the aromatic solution in the coffee, begins with the first contact between pre-dried coffee and solution with concentrated aromas. This phase is considered as completed when the liquid to be reincorporated is totally absorbed by the coffee. The advantage of using a peristaltic pump is that the solution is not in contact with extraneous parts that could pollute and the association of the peristaltic pump with transparent tubes, for example of silicon, is to watch through said tubes the development of the reincorporation phases: an initial step of continuous flow of the aromatic solution up to a discontinuous flow and then a total absence of flow which indicates that the coffee “drank” all the solution. This represents the end of the first reincorporation phase.

The second phase, much longer than the first one in term of time and that in fact has already started during the first phase, regards the diffusion of the aromas from the outer surface of the grains to the “core”, the grain innermost part.

This diffusion phenomenon is made easy and possible thanks to the vacuum generated by the aroma recirculation pump which is left running even after the end of the first reincorporation phase.

The diffusion of the aromas more into the grains of decaffeinated coffee avoids an excessive loss of aroma during the next phase of final drying, on the one hand, and during the coffee roasting phase, on the other hand.

For illustration purposes, the results achieved in watching the reincorporation phases are shown here below:

A) Still in an extractor of 50 L capacity, equipped with heating coils and a stirrer, 10 kg of green coffee are loaded therein along with 30 L of softened water brought to a temperature of 85° C. After one hour, the solution is recirculated at a rate of 60 L/hour through a first column loaded with 1.6 kg of active carbons of the type GAC (Granular Activated Carbon) coming from a previous batch of coffee where the recirculation time period was four hours. After two hours, the solution is totally discharged from the extractor and recirculated through a second column loaded with 1.6 kg of fresh active carbons. After four hours, the recirculation of the aromatic solution is stopped and the solution, with a number of Brix equal to about 5%, is separated from the beans. The latter are dried up to about 15% moisture and mixed with the aromatic solution that was concentrated before up to a number of Brix approximately equal to 17%.

In this case, the reincorporation is done by continuing the mixing between the coffee and the aromatic solution during six hours at 80° C., at atmospheric pressure. At the end, the coffee is dried with hot air at 85° C. until a moisture content of 10% is achieved. The coffee is then cooled and shows a colour darker than the one of the original coffee.

B) The decaffeination process as described under A) is repeated with a change in the method of reincorporation and in the operating times: in this case the reincorporation takes place while maintaining the mixing between the coffee and the solution at a temperature of 80° C. and using a peristaltic pump for the recirculation of the concentrated solution. The system remains in slight vacuum between 0.8 and 0.99 bar. After two hours, the coffee absorbed all of the solution. Leaving the peristaltic pump in operation, the process stops after:

5 hours of reincorporation (first phase 2 hours, second phase 3 hours),

6 hours of reincorporation (first phase 2 hours, second phase 4 hours).

At the end of the operation, the coffee is dried to a moisture content of 10% and cooled.

All the coffee is roasted in a “Petroncini” roaster of 2 kg coffee capacity. Coffees having similar roasting degrees and time periods have been considered. The annexed Table 3 summarizes the results of the group of assessors in the sensory evaluation of a beverage obtained with the brewing method known as “espresso” (a coffee beverage obtained in about 25-30 seconds with warm water around 90° C. under pressure from 7 to 10 bar and volume between 25 and 30 ml).

The Plant Implementing the Process.

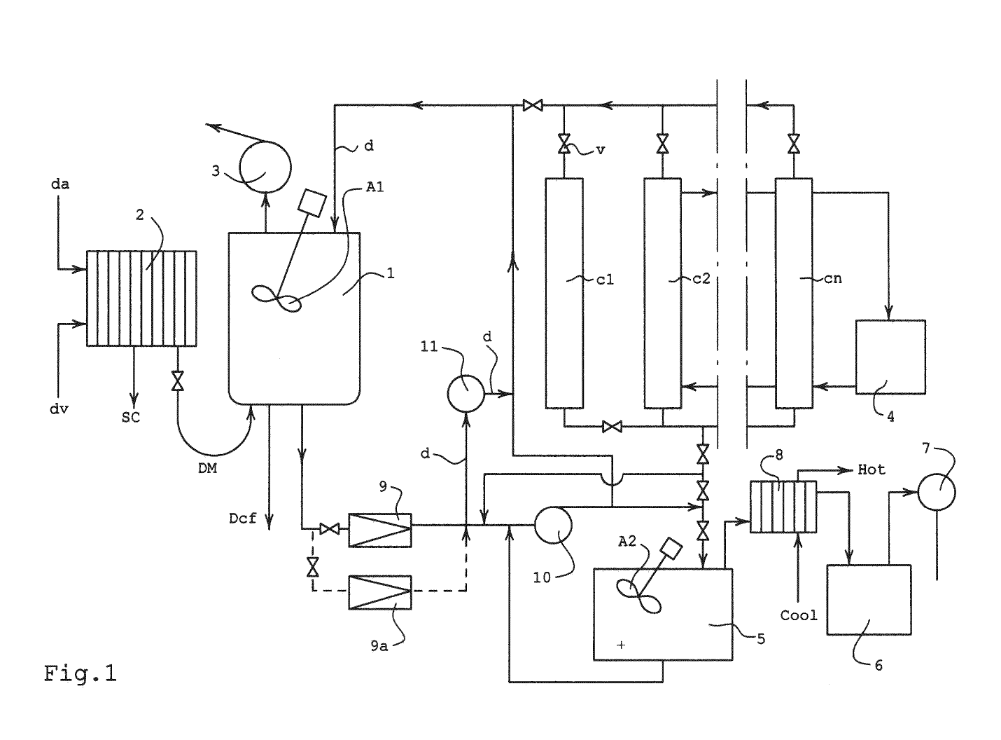

The plant implementing the process comprises the parts that, connected together and controlled manually and/or automatically by means of conduits and valves, are defined in the claims with reference to FIG. 1 which diagrammatically illustrates the basic parts of the plant through an example of embodiment.

TABLE 1

| Recirculation time | Residual caffeine in decaffeinated |
|---|---|
| Min | coffee after reincorporation (%) |
| 0 | 1.50 |
| 24 | 1.12 |
| 48 | 0.84 |
| 72 | 0.60+ |
| 96 | 0.48 |
| 120 | 0.36 |
| 144 | 0.26 |
| 168 | 0.20 |
| 192 | 0.16 |
| 216 | 0.12 |
| 240 | 0.08 |
| 264 | 0.06 |
| 288 | 0.05 |
| 312 | 0.05 |
| 336 | 0.04 |
| 360 | 0.04 |

TABLE 2

| | Recirculation time | Residual caffeine in decaffeinated |
|---|---|---|
| Stadiums | Min | coffee after reincorporation (%) |
| 1st stage | 0 | 1.50 |
| | 24 | 1.16 |
| | 48 | 0.92+ |
| | 72 | 0.76 |
| | 96 | 0.70 |
| | 120 | 0.68 |

Change absorber

| | | |
|---|---|---|
| 2nd Stage | 144 | 0.44 |
| | 168 | 0.32 |
| | 192 | 0.24 |
| | 216 | 0.18 |
| | 240 | 0.14 |
| | 264 | 0.10 |
| | 288 | 0.08 |
| | 312 | 0.07 |
| | 336 | 0.05 |
| | 360 | 0.04 |

TABLE 3

| | | | | | Average |
|---|---|---|---|---|---|
| Example | Aroma | Body | Taste | Ranking | Rating |
| 1 | Weak | Weak | Light wood, | 3° | 5.1 |
| | | | Popcorn | | |
| 2-A | Medium, | Acceptable | Balanced, | 2° | 6.9 |
| | Fresh | | lightweight | | |
| | | | boiled | | |
| 2-B | Good, Full, | Good | Balanced, | 1° | +7.2 |
| | Pan roasted | | aromatic | | |

1-14. (canceled)

15. Process for removing caffeine from green coffee in which a batch of green coffee is introduced in at least one extractor (1) containing softened water maintained at a conventional working temperature comprised between 60° C. and 90° C. and the coffee beans in the hot water are left for the time period necessary in that they swell so that caffeine is transferred to the hot water and a solution forms that comprises aromatic softened hot water and part of the transferred caffeine and aromatic water-soluble substances contained in the coffee, where steps are implemented to absorb the caffeine contained in the above aromatic solution as decaffeinated by active carbons placed in at least a suitable container provided at its entry of a filter (9, 9a) suitable to retain undesired solid elements, wherein the process comprises the phases of: pre-drying in the extractor (1) the aromatic solution decaffeinated by the active carbons; concentrating said solution in a concentration apparatus (5) and transferring it again into the extractor (1) held in a vacuum degree (11) ranging from 0.65 to 0.99 bar that helps the reincorporation of aromatic substances in the pre-dried coffee; drying, cooling and discharging the decaffeinated coffee.

16. Process according to claim 15, wherein the aromatic solution is kept agitated in the extractor (1) by a stirrer means (A1) suitable to impart to the mass “aromatic solution-coffee” a mixing movement, the grains of coffee being retained by a porous septum at the exit of the extractor, while the solution and the coffee films are allowed to pass through said porous septum.

17. Process according to claim 15, wherein the aromatic solution is first moved in a first container of activated carbons (C1) and, then, one or more times, again in the extractor (1) in which further amounts of caffeine are transferred from the coffee to the solution.

18. Process according to claim 15, wherein the aromatic solution is first transferred from the extractor (1) to a first container of activated carbons (C1) partially saturated with caffeine and, then, from said first container (C1) in at least a second between several containers (C2-Cn) of fresh active carbons that absorb caffeine and again the solution is transferred one or more times in the extractor (1) in which further amounts of caffeine are transferred from the coffee to the solution, such procedure causing substantially the total saturation of each column of active carbons (C1-Cn).

19. Process according to claim 18, wherein the containers of active carbons (C2-Cn) are used in series in the case in which the control on line of the caffeine shows values higher than those expected.

20. Process according to claim 18, wherein the containers of active carbons (C2-Cn) are used in parallel in case the control on line of the caffeine shows values higher than those expected.

21. Process according to claim 18, wherein the entry of the solution into the containers of active carbons (C1-Cn) arranged in parallel or in series takes place both from the bottom to the top and from the top to the bottom.

22. Process according to claim 18, wherein the residue of the solution still present in the containers of active carbons (C1-Cn) is totally removed by a suitable pump (10).

23. Process according to claim 15, wherein condensed water during the concentration step (5) is recovered and reused as water for swelling the batch of coffee in the coffee to be treated subsequently.

24. Process according to claim 15, wherein the swelling of the coffee in the extractor (1) is performed by recirculating the water in a loop (1-9-11-1) through the extractor (1), a filter (9) and a pump (11) and putting the water back into the head of the extractor.

25. Process according to claim 15, wherein the state of vacuum in the extractor (1) is generated by a peristaltic pump (11) when it provides for the recirculation (1-9-11-1) of the aromas to be reincorporated by withdrawing the aromatic solution from the bottom of the extractor (1) and putting it on his head in the same extractor.

26. Plant for implementing the process according to claim 15, which comprises:
an extractor (1) adapted to contain a mixture of coffee and softened hot water maintained at a desired temperature, provided with means (A1) for imparting to the mixture a mixing movement,
a first column of active carbon (C1) partially saturated with caffeine suitable to extract caffeine from the solution,
at least one of a second between several containers (C2-Cn) of fresh active carbons suitable to extract caffeine from the solution,
a battery (2) fed with a fluid at a controlled temperature, hot to heat air for the extractor (1) in the phases in which the decaffeinated coffee is pre-dried or dried and, alternatively, at room temperature or cooled to bring air at ambient temperature or lower in the phase in which the decaffeinated coffee is definitively cooled,
a fan (3) associated with the extractor (1) to inhale the air in the phases of pre-drying and drying of the solution and of cooling the coffee,
means (4) suitable to maintain at the desired temperature the solution circulating in the columns of activated carbons (C1-Cn),
a first container (5) provided with a stirrer (A2) for receiving the aromatic solution at the end of the phase of extraction of caffeine and to concentrate the solution before sending it in the extractor (1),
a second container (6) that collects the water extracted from the solution in the concentration step,
a first vacuum pump (7) to be activated in the phase of concentration of the solution,
a condenser (8) suitable to condense the water vapor coming from the first container (5), which is equipped with an input (Cool) for the cooling water and an outlet (Hot) for the heated water,
a first filter (9) suitable to retain solids that are present in the solution directed to the columns of activated carbons (C1-Cn),
a second filter (9a) suitable to retain solid elements that are present in the solution directed to the columns of active carbons (C1-Cn), which second filter is made operative when the first filter (9) is in maintenance,
a second pump (10) suitable to circulate the solution present in the columns of active carbon (C1-Cn), to send in the extractor (1) the aromatic solution which was concentrated in the first container (5) and to completely empty the solution still present in the columns of active carbons (C1-Cn),
a third pump (11) suitable to recover the concentrated solution from the bottom of the extractor (1) to send it to the top of the extractor during reincorporation and achieve a vacuum of between 0.65 and 0.99 bar that improves the reincorporation of aromas into the decaffeinated coffee.
a conduit dA for introducing ambient air into the heating and cooling battery (2),
a conduit dV for introducing superheated steam into the heating and cooling battery (2),
a conduit SC for discharging the condensed fluid from the heating and cooling battery (2),
a conduit dM for sending in the extractor (1) hot or cold air coming from the battery (2),
an opening Dcf for downloading the decaffeinated coffee from the extractor (1),
ducts (d) and valves (v) suitable to implement the process.

27. Plant according to claim 26, wherein the third pump (11) is a peristaltic pump.

28. Plant according to claim 27, wherein the peristaltic pump (11) is associated with transparent ducts (d) at least to the downstream.
